(19) United States
(12) Patent Application Publication
(10) Pub. No.: US 2006/0054687 A1
(43) Pub. Date: Mar. 16, 2006

(54) System and method for an integrated entertainment device network

(76) Inventors: Peter Betti, Dallas, TX (US); William Seibert, Bayville, NJ (US)

Correspondence Address: SOFER & HAROUN, LLP, Suite 910, 317 Madison Avenue, New York, NY, 10017, US

(21) Appl. No.: 10/939,946

(22) Filed: Sep. 13, 2004

(51) Int. Cl. G06K 5/00

(52) U.S. Cl. 235/380

(57) ABSTRACT

An integrated entertainment device network is provided using a unique debit card issued to a subscriber. A plurality of debit card readers are provided, each of which are coupled to a corresponding entertainment device. A debit card hub is coupled to each of the debit card readers and configured to track the usage of the subscriber via the debit card. A management database is configured to receive the usage tracked by the debit card hub, and generates a corresponding incentive to be redeemed by the subscriber using the debit card.

### FIELD OF THE INVENTION

The present invention is directed to an integrated entertainment device network. More specifically, the present invention is directed to an integrated entertainment device network utilizing a unique debit card.

### BACKGROUND OF THE INVENTION

In the field of entertainment devices, such as video games, slot machines and the like, many recent developments have improved on their quality including the integration of multiple video game units, inter module play, advanced memory cards and other such improvements. Arcade game establishments are facing competition from many other sources, such as home entertainment devices that can provide high quality video game graphics via computer terminals, television sets or personal devices. As such, the arcades are constantly exploring on newer and better ways to entice consumers.

As such many advances have been accomplished in the arcade industry. These advances are all directed towards improving the quality of the games for the players, by adding upgraded features. Similar devices, such as vending machines, touch screen games, photo booths or any other such kiosks have also undergone a number of improvements.

Yet another example of advancements in the field of entertainment devices is the use of personal memory cards such as those used in slot machines or certain arcade games. In those instances, the user of the device is given a card that is placed in the device during use. In the case of slot machines the card may store a dollar amount played on that device or, in the case of video games, it may store a certain game session so that the user can return later and start from the same position.

In addition to improvements to the quality of the devices themselves, many entertainment devices now utilize card payment systems rather than standard coin or bill payment. This increases the options available to the user to access certain devices without relying on older bill payment acceptors.

However, although there have been a number of improvements to the quality of entertainment devices and other such automated sales devices, the prior art still has yet to develop means for improved customer retention and customer loyalty.

### OBJECT AND SUMMARY OF THE INVENTION

Therefore, it is the object of the present invention to overcome the drawbacks associated with prior art systems and to provide an integrated entertainment device network for tracking and compiling data, using a unique debit card, for a particular individual using a plurality of entertainment devices on the network.

It is further object of the present invention to generate a series of incentives and bonus based on the compiled data for that particular individual. Such incentives may be utilized to encourage additional use of the entertainment devices, and also to retain customer loyalty, through their user.

To this end the present invention provides for a

### BRIEF DESCRIPTION OF THE DRAWINGS

The objects and advantages of the integrated entertainment device network of the present invention will be readily apparent from the reading of the following detailed description of the device constructed in accordance with the invention by reference to the accompanying drawings thereof wherein:

FIG. 1 illustrates a system diagram for an integrated entertainment device network, in accordance with one embodiment of the present invention;

FIG. 2a illustrates an individual location diagram from the integrated device network of FIG. 1, in accordance with one embodiment of the present invention;

FIG. 2b illustrates a functional diagram of the debit card reader in accordance with one embodiment;

FIG. 2c illustrates a memory entry field relating to a subscriber in accordance with one embodiment of the; and

FIG. 3 is a flow chart illustrating the operation of integrated entertainment device network of FIG. 1, in accordance with one embodiment of the present invention.

### DETAILED DESCRIPTION OF THE PREFERRED EMBODIMENT

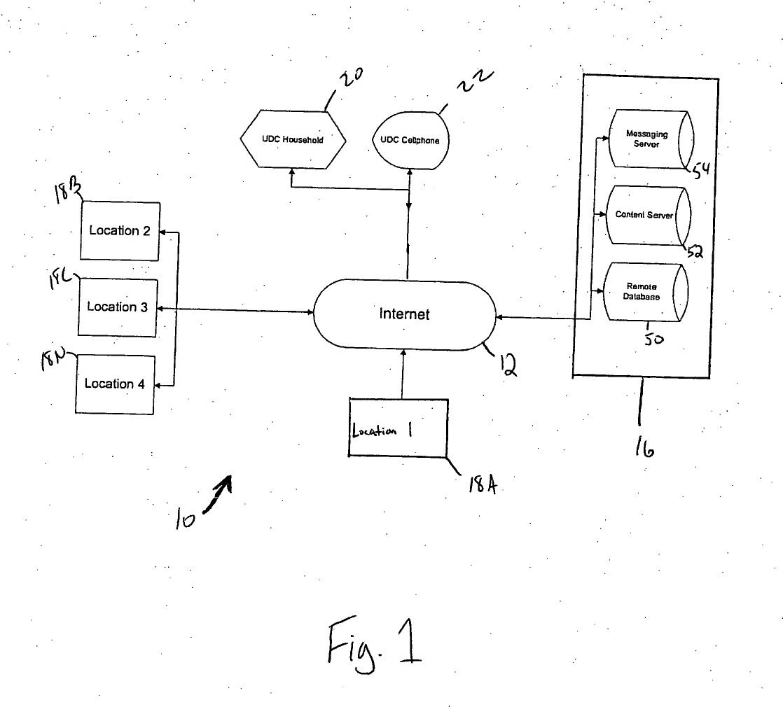

Referring now to the drawings wherein like references characters represent like and corresponding parts throughout the several views, there is illustrated in FIG. 1 an integrated entertainment device network 10 in accordance with one embodiment of the present invention, although the invention is not limited in scope in that respect. As illustrated, network 10 is comprised of number of components all linked via a central internet 12 connection. It is understood that internet 12 connection could be replaced with a WAN (Wide Area Network), maintaining dedicated connections between the various components of network 10, or any other communications network as those employed by one skilled in the art.

For the purposes of illustration all remotely located modules within integrated entertainment device network 10 communicate via internet 12. As illustrated in FIG. 1, network 10 is comprised of a management module 16, a series of operation locations 18A . . . 18N and user home terminal 20 and user mobile terminal 22, are coupled by internet 12. System 10 allows a plurality of subscribers to utilize its many features via devices located in each of locations 18A . . . 18N, or terminals 20 and 22, as will be explained in more detail below.

Management module 16 includes a messaging server 54, which is configured to generate messages addressed to the subscribers of the system. These messages may be sent to the subscribers via email, SMS messaging, voice mail and other types of messaging as known by those skilled in the art.

Management module 16 also includes a content server 52, which is configured to provide content for use by subscribers who visit network 10's website. Such content may include login information for allowing subscribers to log into the site. It also contains arrangements to allow new subscribers register with the system. Other information, such as subscription history, and subscription tracking information can also be provided via content server 52.

Management module 16 also includes a remote database server 50. Database server 50 is configured to store all relevant information corresponding to the use and operation of network 10 as will be described in more detail hereinafter.

This network 10 makes use of unique debit card (UDC) 14 that is issued to a subscriber, referred to throughout as UDC 14 subscriber, who typically frequents locations 18A-18N employing the devices within integrated entertainment device network 10. As UDC 14 is issued and used in the first instance at any one of locations 18A-18N, the issuing and operation of UDC 14 at location 18A are discussed in detail first. It is noted that although the present embodiments of the invention refer to a debit card 14, the invention is not limited in scope in that respect and any form of access card can be used in accordance with the principles of the present invention.

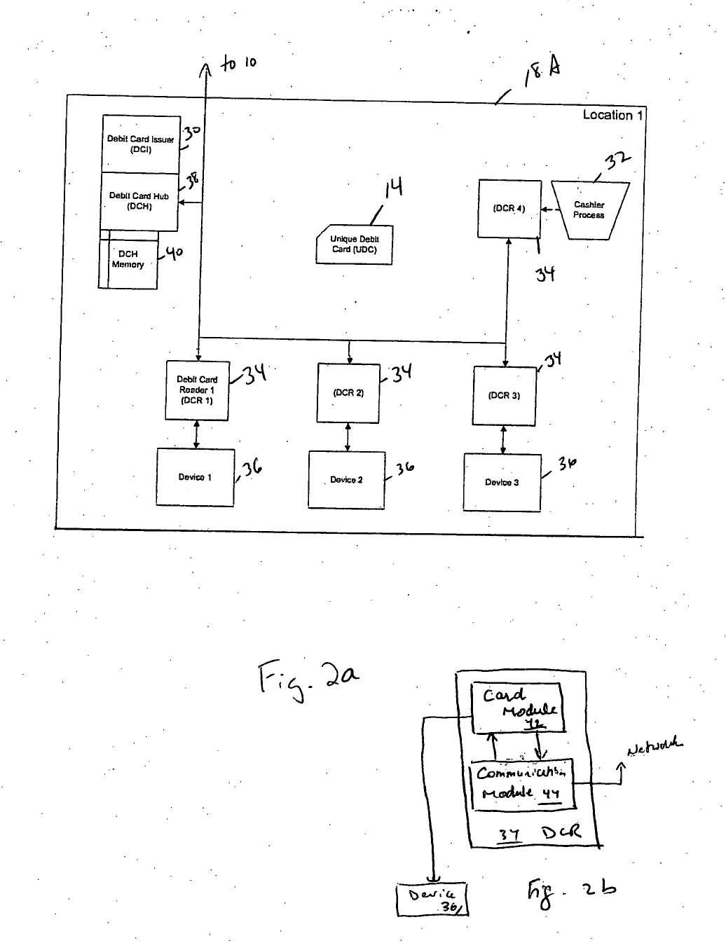

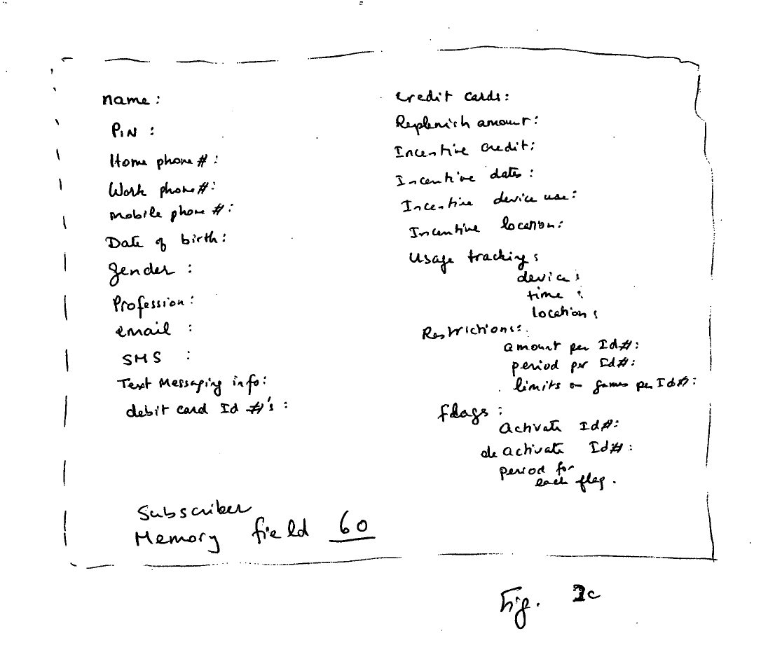

In accordance with one embodiment of the invention, each of the locations 18A through 18N contains a plurality of devices as illustrated in FIG. 2a, as illustrated in accordance with one embodiment of the present invention, although the invention is not limited in scope in that respect.

Although the actual configuration and arrangements of modules within each location 18A-18N may vary, their essential features remain the same.

A debt card issuer 30 is provided at location 18A, configured to produce and encode a debit card (UDC) 14 for each individual subscriber using network 10. Although debt card issuer 30 is shown as an independent module within location 18A, it is contemplated that debt card issuer may be located external to location 18A whereby debit card (UDC) 14 may be issued to a user via mail or other means rather than being issued directly at location 18A. For the purposes of illustration, debt card issuer 30 will be shown to be physically located at location 18A.

According to one embodiment of the invention, each location 18 advantageously includes a local area networking to which a plurality of devices are coupled. Location 18 may be a video arcade establishment, or any other establishment that contains gaming devices. As such location 18 includes devices 36 coupled to the network via a corresponding debit card reader (DCR) 34.

In one embodiment of the present invention at location 18A, a number of entertainment devices 36A-36N are provided for use by the subscribers who carry a corresponding debit card 14. It is contemplated that entertainment devices may include but are not limited to video games, photo booths, vending machines, touch screen games, slot machines, video poker machines, mechanically operated games (skee-ball, pachinko, etc. . . ), internet access consoles and pay per view television consoles. With each of entertainment devices 36 the subscriber inserts a debit card (UDC) 14 into the accompanying debit card reader 34, which deducts the appropriate dollar amount and allows access to the desired functions.

As will be explained in more detail in reference with FIG. 2b, each debit card reader 34 is configured to retrieve information provided by a subscriber's debit card (UDC) 14, so as to allow the use and operation of the corresponding device 36.

Location 18 also includes a debit card reader 34, which is coupled to a cashier process 32. The subscriber may insert their debit card (UDC) 14 so as to allow the use of the card to pay for goods and services provided at location 18 and charged by cashier process 32. It is also contemplated that cashier process 32 may make allowances to automatically refilling a subscriber debit card via credit card or bank debit card, the information for which is provided when UDC 14 is first obtained.

Location 18 also includes a debit card hub 38, which is configured to process and handle the operation and use of debit cards 14 at location 18. A debit card hub memory 40 is coupled to debit card hub 38 so as to store all relevant and necessary information concerning the use and operation of debit cards 14 at location 18.

FIG. 2b illustrates a debit card reader 34 in more detail. Accordingly, each debit card reader 34 includes a card module 42 and a communications module 44. Card module 42 is coupled to communications module 44. Furthermore, card module 42 is coupled to a corresponding device 36. Communications module 44 is coupled to local area network of FIG. 2a. Card module 42 is configured to scan information from a card 14 and write information to the card.

In one embodiment of the present invention, debit card hub 38, acts as a central processor for monitoring all of the activity at each entertainment device 36 throughout location 18A. As a user activates a given entertainment device 36, debit card reader 34 reads the users UCD 14 and sends the related information back to debit card hub 38.

FIG. 2c illustrates a database memory field 60 for each subscriber that has registered with system 10. Each subscriber memory field includes an entry for subscribers information, such as name, PIN number, various telephone numbers, such as home, work, and mobile phone numbers, data of birth, gender, profession, email, SMS and other text messaging information, credit card information for replenishing the available credit for each card 14 registered under the subscriber's name, the amount to be replenished each time the available credit on the card is below a specified threshold, incentive field, which provides incentive credits for use by the subscriber on specified dates for specified games at specified locations, use tracking fields for tracking the usage of various devices by the subscriber, restriction fields such as limits on amounts to spend in each predefined period, limits on games to play, flags for activating and deactivating the corresponding card 14 registered under the user's name for predefined periods of time.

The information for each memory field 60 can be provided via content server 52. Thus each subscriber may access its own account and update various information stored in memory field 60 as can be appreciated by one skilled in the art. As such each subscriber can maintain control over the use of debit cards 14 registered under its name. For example, parent subscribers may modify the restriction fields for each card registered under their name so as to provide age appropriate restrictions for their children's use.

Furthermore, managing server 54 can provide reporting statements that provide an update for each account with the history of usage for each card registered under the user's name such as the types of games used, the period for each game, the dates of use and the corresponding amount for each use.

Upon entering a location 18A, the subscriber obtains a debit card (UDC) 14 upon request. At the time of obtaining the UDC 14, the subscriber is requested to give at least a minimum amount of personal information such as name and PIN number. Additional personal information requested may include home address, e-mail, mobile number, credit card or bank account information and other such personal information. Incentives, including free credits, may be given at the time UDC 14 is initially offered to encourage the holder to give more information. Irrespective of the amount of information collected, UDC 14 holder should give a password or PIN (Personal Identification Number) so to provide security to the device and to access devices connected to network 10, although UDC 14 may be issued in a form not requiring such a PIN. It can be appreciated by those skilled in the art that a debit card 14 can be ordered via access to the system's website, and each subscriber can order as many debit cards as desired.

Each debit card (UDC) 14 is contemplated as being a permanent card possessed by the holder for long term use and tracking by network 10. However, it is possible that network 10 may issue limited access or limited term UDCs 14. Such limited use versions of UDC 14 may be used for promotional reasons.

For example, network 10 may set up an advertising deal with a radio station, whereby the radio station raffles off a large number of pre-programmed limited access debit cards (UDCs) 14. These UDCs 14 can then be used to track the effectiveness of the promotion and also to give the holders a chance to use network 10, possibly encouraging them to obtain a permanent UDC 14. For the purposes of illustrating the salient features of UDC 14 within network 10, the permanent or long term UDC 14 will be used.

While the functions of UDC 14 are discussed in detail with respect to entertainment devices 36, it is also within the contemplation of the present invention, to use network 10 in conjunction with standard retail stores and restaurants as well. For example, provided a card reader 34 is maintained at the retail store or restaurant cashier, the retailer or other food services location can accept UDC 14, expanding the options available to network 10 for generating incentives for the users. However, for the purposes of illustration, entertainment device 36 will be used throughout to detail the salient features of the present invention.

In particular, as a user employs a particular entertainment device 36, debit card reader 34 scans the information on the card and provides the information to debit card hub 38. Debit card hub 38 makes a note of the duration of time spent at the device, the amount of money spent, the date and time of use, and the subscriber as identified by their UCD 14. The debit card hub 38 also checks the memory field 60 relating to the subscriber for all restrictions provided for the card and sends appropriate signals to debit card reader 34 so as to provide access to device 36 in accordance with the specified restrictions.

Once debit card hub 38 determines that the user of card 14 can have access to device 36, it sends an appropriate signal to the card module of reader 34, which in turn provides an activation signal to device 36, allowing the use of the device.

It is understood, that the example of information being tracked by debit card hub 38 is only an example of possible data being tracked, however, tracking any such usage data, is within the contemplation of the present invention.

As the data is collected, debit card hub 38 processes the information and complies it according to certain parameters. One such example of a method of compiling data is to compile the data of a particular debit card (UDC) 14, so as to generate a profile of a particular user's habits and usage patterns. A second exemplary method of compiling data is to generate a profile for a particular entertainment device 36 or group of devices so as to track their usage and profitability.

After debit card hub 38 compiles the data from debit card readers 34, it then stores the information in debit card hub memory 40. Although debit card hub memory 40 is shown in FIG. 2 as a separate unit from debit card hub 38, it is understood that debit card hub memory 40 may also be located either within debit card hub 38 or remotely located, possibly outside of location 18A. Irrespective of the location of debit card hub memory 40, the compiled data is stored for a given duration, for example, until debit card hub 38 delivers the information to management module 16, shown in FIG. 1.

As previously mentioned management database 50 stores the information for each debit card (UDC) 14 employed in network 10 that was compiled by debit card hub 38. This includes data from each of the debit card hubs 38, located throughout network 10 at the various locations 18A-18N, each of which operate similarly. As such, it is contemplated that the usage, by a single subscriber using one or more debit cards (UDC) 14 registered under his name, may be tracked not only at various entertainment devices 36 at a single location 18A but also may be tracked throughout all of the entertainment devices 36 at all of the locations 18A-18N that are within network 10.

After all the data is complied for a particular subscriber by way of their tracked UCD 14 information, management database 50 compares their stored information against a given set of criteria to generate an incentive package for UCD 14 holder.

Although the scope of possible parameters for generating incentive package is too large to disclose in detail, the salient features of the invention, in this respect can be readily understood from the following examples.

In a first example, by tracking UCD 14 by debit card hubs 38, a particular user is noted to frequent a particular type of video poker entertainment device 36, at one particular location 18A, typically between the hours of 8-10 PM on either Tuesdays or Wednesdays, and spends approximately $100.00 per night. Also in this situation, the incentive parameters of management database 50 are set to recognize usages of a particular type of entertainment device 36 that is housed in several different locations 18A-18N and to use that information to distribute customers to other locations.

Thus, in this case, management database 50 observes that debit card (UDC) 14 holder is playing a particular video poker entertainment device 36 at location 18A and generates an incentive to play the same video poker entertainment device 36 at a different, under trafficked location 18B. To this end , management database 50 generates an incentive package for UDC 14 holder whereby if he travels to location 18B which also has this user's favorite video poker device, he will receive extra money credits to his UDC 14 (bonus dollars or 2 for 1 credits), complimentary meals or other such incentives.

The data compiled regarding the time and frequency of the subscriber's use of the entertainment device 36, such as duration at the machine, time, date and amount spent is used to both tailor the incentive for the particular subscriber and to provide an incentive that moves foot traffic to location 18B at a certain time, when they are typically experiencing a lull.

In another example, by tracking the usage of a debit card (UDC) 14, a particular subscriber is noted to frequent a particular location 18A, playing various video game entertainment devices 36, typically between the after school hours of 3-5 PM on weekdays, and spends approximately $35 a week. As mentioned earlier the subscriber is notified via a plurality of different communication arrangements, such as voice mail, email, text messaging or SMS.

The incentive parameters of management database 50 in this situation are set to recognize usages of a particular time frame at location 18A and to use that information to increase attendance at the same location at a different time.

Thus, in this case, management database 50 observes that debit card (UDC) 14 holder is playing video game entertainment devices 36 at location 18A in after school hours and generate an incentive to play at the same location 18A on off peak hours such as early weekends. Here, management database 50 will generate an incentive package for UDC 14 holder whereby if the user travels to location 18A on Saturday or Sunday mornings, they will receive extra money credits to their UDC 14, or free snacks from vending machines on site.

In a third example, by tracking a debit card (UDC) 14 a particular user is noted frequent many locations 18A-18N and to use a wide variety of entertainment devices 36, typically on weekends, and spends approximately $50 per night. Here, the incentive parameters of management database 50 may be set to recognize users who frequent many locations 18A-18N and entertainment device 36 so as to test/introduce new games or locations and to simply reward valuable customers.

In this case, management database 50 reviews the data that shows that UDC 14 holder is playing multiple entertainment devices 36 at multiple locations 18A-18N, indicating a general and widespread enjoyment of entertainment devices, and thus generates an incentive to play a newly introduced entertainment device 36 or an incentive to play at a new location 18N. Here, the incentive package for UDC 14 holder provides rewards whereby if they travel to a new location 18N or play a new entertainment device 36 they receive credits allowing them to play a number of entertainment devices at half price or free (for a limited time) or other such incentives.

Based on the UDC 14 holder's duration of play at these new games, network 10 evaluates the reception the entertainment device will receive in wider distribution. Also, by rewarding a specific good customer, the incentives work to ensure that they continue to return to locations 18A-18N within network 10.

In accordance with another embodiment of the invention a system administrator can set parameters for which a debit card (UDC) 14 is usable with an associated surprise reward for the subscriber on certain networked locations for certain days, times and monetary amount. For example, a subscriber may be given a surprise award, for example additional play credits on the debit card at certain times or days of the week. The subscriber is then provided with a message that additional bonuses may be awarded if the subscriber provides detailed personal information to the system.

As is evident from the above examples, the number of possible parameters upon which management database 50 can generate incentive packages from the data recorded at debit card hubs 38 are too numerous to list in detail. Any system which employs a similar management database 50 to analyze stored data from customers, tracked by their use of debit card (UDC)s 14 and the debit card hubs 38, so as to generate incentive packages in a similar manner is within the contemplation of the present invention.

In one embodiment of the present invention, content server 52 of management module 16 is configured to store corresponding incentives in remote database 50 for each subscriber's memory field so as to allow the delivery of credits at the points of redemption. In this respect, each debit card hub 38 at each location checks the available incentives stored at remote database 50 so as to provide those incentives to each subscriber.

Thus, when a subscriber whose memory field 60 includes incentive credit information, inserts a debit card (UDC) 14 in a debit card reader 34, the card module scans and retrieves the identification number of the card and provides the information to the communication module, which then sends that information to debit card hub 38. A copy of the subscriber memory field 60 may reside at debit card hub 40 memory. Alternatively debit card hub 38 sends the information to content server 52 to locate the subscriber's memory field 60. The incentive credit information is then checked to determine whether the subscriber is entitled to any awards for inserting the debit card 14 in the debit card reader.

Another possibility is that certain incentives generated by management database 50 may be issued directly to UDC 14 holder, rather than being redeemable at a location 18A. For example, one such incentive may be to provide a user with a coupon/e-coupon after a predefined amount of usage is reached on UDC 14. In such an instance, content server may work in conjunction with message server 54, described in detail below, to directly send the incentive to UDC 14 holder's home contact 20 or mobile contact 22.

In one embodiment of the present invention, as illustrated in FIG. 1 messaging server 54 of management module 16 is configured to notify subscribers via Internet 12 that an incentive has been issued. Notification can be sent to either home contact 20 or mobile contact 22, based on the preferences of the subscriber that were entered when they initially enrolled in the system.

In addition to supplying notification of incentives, messaging server 54 can also periodically request updated personal information from the subscriber, in addition to the information collected when the card was issued.

It is understood that the above description of the elements and modules described above in connection with integrated entertainment device network 10 can be arranged in other configuration and may also be either combined with one another or their functions be separated in to two separate modules as necessary.

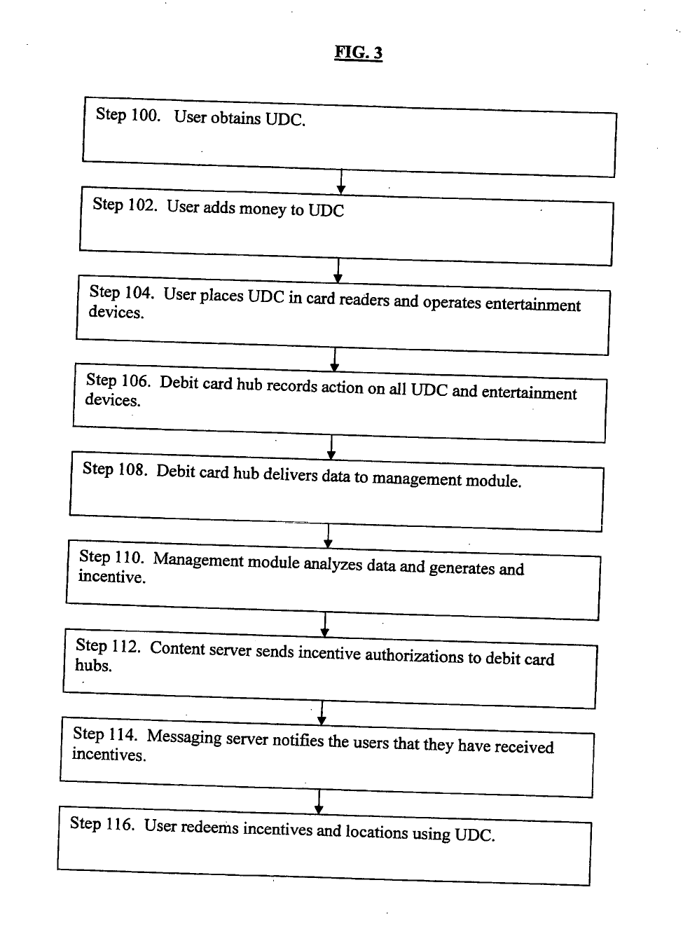

Having described the components of network 10, in one embodiment of the present invention, illustrated in FIG. 3, an exemplary flow chart is presented describing its operation.

At step 100, an individual enters a location 18A on network 10, or alternatively contacts network 10 directly via internet 12, and enters personal information, described above, and is issued a debit card (UDC) 14 by debit card issuer 30. Next at step 102, UDC 14 holder adds money/credit to the card either at cashier station 32 or directly via personalized information, such as from previously stored credit/debit card information.

At step 104, a debit card (UDC) 14 holder begins operating entertainment devices 36 at location 18A by placing UDC 14 into the various attached card readers 34. As debit card (UDC)14 holder uses the various entertainment devices 36, debit card hub 38 collects and aggregates the information and stores it on debit card hub memory 40.

At step 106, debit card hub 38 transmits the stored data for all UDC 14 holders and entertainment devices 36 at location 18A to management module 16 of network 10 via internet 12. At step 108, management database 50 of management module 16 compiles all of the data from all debit card hubs 38 from each of locations 18A- 18N and generates compiled profiles for all of UDC 14 holders, as well as any other desired profiles such as for individual locations 18A or entertainment devices 36.

Next, at step 110, after management database compiles all the necessary data, the data is analyzed against a predefined set of parameters, which are used to generate incentives for each UDC 14 holder once generated, at step 112, the incentives are stored in each subscriber's memory field 60 and if appropriate a copy of the incentive information is delivered by content server 52 via internet 12 to the appropriate debit card hubs 38 at each of locations 18A-18N. At step 114, messaging server 54 notifies UDC 14 holders of the incentives.

As an alternative to step 112, where a copy of the incentive information is sent to debit card hubs 38 as soon as they are generated, it is contemplated that management module 16 may hold the incentives/authorizations information in management database 50 until UDC 14 holder goes to location 18A and attempts to use the card. In such an instance, when the holder places UDC 14 into card reader 34, network 10 can recognize their presence in real time and send the incentive information to the appropriate debit card hub 38 to be credited to UDC 14 in direct response to their redemption. This arrangement, utilizing high speed internet 12 connections, may be implemented as an alternative where debit card hubs 38 are of limited storage capacity or if the incentives are not location 18A specific. However, for the purposes of illustration, the incentives generated by management database 50, are described herein as being delivered to debit card hub 38 as soon as they are generated.

At step 116, UDC 14 holder, wishing to redeem the incentives, enters the appropriate location 18A and is credited with the incentive at either cashier station 32 or one of the number of debit card readers 34 at entertainment device 36, or when attempting to use a game device 36.

Thus, the present invention provides for an integrated entertainment device network 10 that is capable of monitoring usage patterns of individuals at participating locations by tracking their use using a unique debit card, Personalized for the holder. Using this card incentives and promotions can be directed to the unique debt card holder for any number of advantageous purposes such as improved customer loyalty, evaluation of certain entertainment devices, or cross promotions to other locations, devices or services, such as on location restaurants. Furthermore, each subscriber is able to provide appropriate restrictions on the use of one or more debit cards registered in its name, so as to control the use of the debit cards that a subscriber hands out to others.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An integrated entertainment device network, said device comprising:
a unique debit card issued to a subscriber;
a plurality of debit card readers, each of which are coupled to a corresponding entertainment device;
a debit card hub, coupled to each of said debit card readers, configured to track the usage of said subscriber via said debit card; and
a management database, configured to receive said usage tracked by said debit card hub, said management database configured to generate a corresponding incentive, said incentive to be redeemed by said subscriber using said debit card.

2. The network in accordance with claim 1 wherein each of said card readers comprises a card module configured to retrieve identification information from said debit card.

3. The network in accordance with claim 2, wherein each of said card readers comprises a communication module configured to send and receive information from said debit card hub.

4. The network in accordance with claim 1, wherein said debit card hub is located within an entertainment establishment, and each of said entertainment devices within said establishment are coupled to said debit card hub via a communications network.

5. The network in accordance with claim 4, wherein said debit card hub is coupled to a debit card hub memory unit, said memory unit is configured to store usage information relating to the use of said entertainment devices via said debit cards.

6. The network in accordance with claim 5, wherein a plurality of locations are coupled to said management database via a communications network.

7. The network in accordance with claim 5, wherein said management database further comprises a management remote memory unit configured to store information relating to said subscribers and said usage information received from each of said debit card hub memory units.

8. The network in accordance with claim 1, wherein said management database notifies said subscribers of available incentive awards via voice mail.

9. The network in accordance with claim 1, wherein said management database notifies said subscriber of available incentive awards via email.

10. The network in accordance with claim 1, wherein said management database notifies said subscriber of available incentive awards via SMS messaging.

11. The network in accordance with 1, wherein said incentive awards are provided based on comparison of usage of entertainment devices in a plurality of locations, so as to divert customers to a location with less activity.

12. The network in accordance with claim 1 wherein said management database is further configured to provide reports on usage of said entertainment devices.

13. An integrated entertainment device network, said device comprising:
an access card issuer configured to issue at least one access card for each one of a plurality of subscribers;
a plurality of access card readers, each of which are coupled to a corresponding entertainment device, said access card readers configured to receive an access card so as to enable the use of said entertainment device;
an access card hub, coupled to each of said access card readers, configured to track the usage of said subscriber via said access card; and
a management module, configured to control the operation of said network, said management module comprising a database storage unit that stores usage restriction information on each of said access cards, so as to allow each subscriber to control the usage of access cards registered under their name.

14. The system in accordance with claim 13, wherein said usage restriction information includes the dollar amount that can be charged per access card.

15. The system in accordance with claim 13, wherein said usage restriction information includes the time periods wherein said access cards can be used.

16. The system in accordance with claim 13, wherein said usage restriction information includes the types of games for which said access cards can be used.

17. The system in accordance with claim 13, wherein said usage restriction information includes memory flags for activating and deactivating each one of said access cards.

18. The system in accordance with claim 13, wherein said database storage unit further stores usage tracking information, so as to store the entertainment devices used by each of said access cards, the time wherein said access cards were used and the location wherein said access cards were used.

19. The system in accordance with claim 13, wherein said database storage unit further stores person information of each one of said subscribers and access card identification numbers registered to each of said subscribers.
